(19) United States
(12) Patent Application Publication
(10) Pub. No.: US 2025/0164831 A1
(43) Pub. Date: May 22, 2025

(54) METHOD AND APPARATUS FOR THERMALLY STABLE OPERATION OF AODS

(71) Applicant: Electro Scientific Industries, Inc., Beaverton, OR (US)

(72) Inventors: Mehmet ALPAY, Beaverton, OR (US); Jered RICHTER, Beaverton, OR (US); Tyler HOWE, Beaverton, OR (US); Yuan LIU, Beverton, OR (US); Fumiyo YOSHINO, Beaverton, OR (US); Brian JOHANSEN, Beaverton, OR (US); Scott ROSENBALM, Beaverton, OR (US); Mark UNRATH, Beaverton, OR (US); Manyam KAJA, Beaverton, OR (US); James BROOKHYSER, Beaverton, OR (US); Patrick KAIN, Beaverton, OR (US); Matthew JOHNSTON, Beaverton, OR (US); Steve MELIZA, Beaverton, OR (US); Chris LINDSLEY, Beaverton, OR (US); Andrew STEVENS, Beaverton, OR (US)

(73) Assignee: Electro Scientific Industries, Inc., Beaverton, OR (US)

(21) Appl. No.: 18/840,974

(22) PCT Filed: Feb. 15, 2023
(86) PCT No.: PCT/US2023/062640

§ 371 Date: Aug. 23, 2024

Related U.S. Application Data
(60) Provisional application No. 63/314,437, filed on Feb. 27, 2022.
(60) Provisional application No. 63/314,438, filed on Feb. 27, 2022.
(60) Provisional application No. 63/338,876, filed on May 5, 2022.
(60) Provisional application No. 63/417,889, filed on Oct. 20, 2022.

(51) Int. Cl. G02F 1/11; G02B 26/08; G02B 26/10; H01S 3/106

(52) U.S. Cl. CPC G02F 1/113; G02B 26/0808; G02B 26/101; H01S 3/1068

(57) ABSTRACT

A system includes a first acousto-optic deflector (AOD) for diffracting an incident beam of laser energy to produce and output therefrom a first beam of laser energy and a second beam of laser light, a second AOD arranged to receive the first beam of laser energy and for diffracting the received first beam of laser energy to thereby produce and output therefrom a third beam of laser energy and a fourth beam of laser energy, at least one first beam trap arranged and configured to absorb the second beam of laser energy output from the first AOD, at least one second beam trap arranged and configured to absorb the fourth beam of laser energy output from the second AOD and a controller communicatively coupled to the first AOD and to the second AOD, wherein the controller is configured to operate of the first AOD while not operating the second AOD.

### BACKGROUND

### I. Technical Field

Embodiments of the present invention relate generally to acousto-optic deflectors, laser-processing apparatus incorporating the same, and techniques of operating the same.

### II. Discussion of the Related Art

Referring to FIG. 1, a laser-processing apparatus 100 operative to process a workpiece 102 often includes, among other components, a laser source 104, a positioner 106 and a scan lens 108. The apparatus will also typically include a controller 110 operative control an operation of the laser source 104 and positioner 106. The positioner 106 is operative to reflect, refract and/or diffract the beam of laser energy so as to deflect a beam path 112 along which laser energy in the beam of laser energy travels as it propagates from the laser source 104 to a scan lens 108. Laser energy deflected to the scan lens 108 is focused by the scan lens 108 and transmitted to propagate along a beam axis so as to be delivered to the workpiece 102.

In order to effect extremely rapid deflection of the beam path 112 in two dimensions relative to the workpiece 102 (e.g., along the X-axis and Y-axis, which is orthogonal to the illustrated X-and Z-axes), the positioner 106 can include a galvanometer mirror scanning system and an acousto-optic deflector (AOD) scanning system arranged optically “upstream” of the galvanometer mirror scanning system. The galvanometer mirror scanning system typically includes a pair of galvanometer mirrors arranged optically in series with each other (e.g., such that one galvanometer mirror is operative to deflect the beam path 112 along the X-axis and the other galvanometer mirror is operative to deflect the beam path 112 along the Y-axis). The AOD scanning system typically includes a pair of acousto-optic deflectors (AODs) arranged optically in series with each other. For example, and with reference to FIG. 2, an AOD scanning system can include a first AOD 200 arranged and configured to deflect the beam path 112 along the X-axis and a second AOD 202 arranged and configured to deflect the beam path 112 along the Y-axis.

As will be recognized by those of ordinary skill in the art, AODs utilize diffraction effects caused by one or more acoustic waves propagating through an AO cell to diffract an incident optical wave (i.e., a beam of laser energy, in the context of the present application) contemporaneously propagating through the AO cell. Upon driving an AOD to diffract an incident beam of laser energy, a diffraction pattern is produced that typically includes zeroth- and first-order diffraction peaks, and may also include other higher-order diffraction peaks (e.g., second-order, third-order, etc.). Generally, the amount of optical power diffracted into the first-order diffraction peak (e.g., as compared to the zeroth-order diffraction peak) is determined by the manner in which the AOD is driven to diffract the incident beam of laser energy. As is known in the art, the portion of the diffracted beam of laser energy in the zeroth-order diffraction peak is referred to as a “zeroth-order” beam, the portion of the diffracted beam of laser energy in the first-order diffraction peak is referred to as a “first-order” beam, and so on. Generally, the zeroth-order beam and other diffracted-order beams (e.g., the first-order beam) propagate along different beam paths upon exiting the AO cell (e.g., through an optical output side of the AO cell). For example, the zeroth-order beam propagates along a zeroth-order beam path, the first-order beam propagates along a first-order beam path, and so on.

In FIG. 2, the zeroth-order beam path of the first AOD 200 is identified at 204 and the zeroth-order beam path of the second AOD 202 is identified at 206. Likewise, the first-order beam paths of the first AOD 200 and the second AOD 202 are each identified at 112. Furthermore, the positioner 106 shown in FIG. 2 includes one or more optical components (e.g., one or more mirrors, lenses, etc., generically identified at 208) arranged and configured to relay the zeroth-order beam path 204 and the first-order beam path 112 of the first AOD 200 to the second AOD 202. The positioner 106 shown in FIG. 2 also includes a beam trap 210 arranged and configured to intercept (e.g., block, absorb, etc.) laser energy propagating along the zeroth-order beam path 206 (as well as laser energy propagating along the second- or higher order beam paths) without intercepting laser energy propagating along the first-order beam path 112.

The AO cell of an AOD will absorb some amount of the beam of laser energy that propagates through it. If the beam of laser energy is sufficiently high in power, the absorbed energy can locally heat the material from which the AO cell is formed and induce a thermal lensing phenomenon within the AO cell. Thermal lensing can focus, defocus, or otherwise distort the wavefront of the beam of laser energy propagating along the beam path 112. Thermal lensing within an AO cell is not, by itself, necessarily undesirable. If the thermal gradient within the AO cell is relatively constant and stationary (e.g., while processing the workpiece 102), then wavefront distortion effects (e.g., focusing effects, defocusing effects or other wavefront distortions, as noted above) can usually be taken into account to ensure that the workpiece 102 is satisfactorily processed. However, if the thermal gradient within the AO cell is not relatively constant or stationary, then it becomes very difficult to adequately compensate for changes in wavefront distortion effects.

In the context of the positioner 106 shown in FIG. 2, the optical component(s) 208 ensure that the optical power incident upon the AO cell of the second AOD 202 is substantially constant, but the location where the zeroth-order beam path 204 is incident on the AO cell of the second AOD 202 may change slightly over time. Thus, the thermal gradient within the AO cell of the second AOD 202 was found to be not suitably constant or stationary, resulting in asymmetric energy distribution (about the optical axis of the beam of laser energy) of laser energy ultimately delivered to the workpiece 102 and degraded ability for the second AOD 202 to accurately deflect the beam path 112.

### SUMMARY

One embodiment of the present invention can be characterized as a system that includes a first acousto-optic deflector (AOD) for diffracting an incident beam of laser energy to thereby produce and output therefrom a first beam of laser energy and a second beam of laser light, a second AOD arranged to receive the first beam of laser energy and for diffracting the received first beam of laser energy to thereby produce and output therefrom a third beam of laser energy and a fourth beam of laser energy, at least one first beam trap arranged and configured to absorb the second beam of laser energy output from the first AOD, at least one second beam trap arranged and configured to absorb the fourth beam of laser energy output from the second AOD and a controller communicatively coupled to the first AOD and to the second AOD, wherein the controller is configured to operate of the first AOD while not operating the second AOD.

Another embodiment of the present invention can be characterized as a system that includes a first AOD operative to diffract an incident beam of laser light to thereby produce and output therefrom a first beam of laser light and a second beam of laser light, a second AOD arranged to receive the first beam of laser light and operative to diffract the received first beam of laser light to thereby produce and output therefrom a third beam of laser light, at least one first beam trap arranged and configured to absorb the second beam of laser light output from the first AOD, at least one exercise beam trap arranged and configured to absorb the third beam of laser light output from the second AOD and a controller communicatively coupled to the first AOD and to the second AOD. The controller is configured to command a first RF driver to apply a first drive signal to a transducer of the first AOD and command a second RF driver to apply a second drive signal to a transducer of the second AOD. The controller is operative to operate the first AOD to diffract the incident beam of laser light along an exercise beam path to the second AOD. The second AOD is configured to diffract the beam of laser light from the first AOD along an exercise beam path to an exercise beam trap. The drive signal is modulated through a range of RF frequencies, thereby controlling a temperature gradient within the first AOD and the second AOD.

### BRIEF DESCRIPTION OF THE DRAWINGS

FIG. 1 schematically illustrates a related art laser-processing apparatus in which a positioner according to embodiments of the present invention may be incorporated and operated according to embodiments of the present invention.

FIG. 2 schematically illustrates a positioner according to the related art.

FIG. 3 schematically illustrates a positioner according to one embodiment of the present invention.

FIG. 4 illustrates a timing diagram for executing a pulse slicing operation according to one embodiment of the present invention.

FIG. 5 illustrates a timing diagram for executing an optical exercising operation according to one embodiment of the present invention.

FIGS. 6 and 7 illustrate timing diagrams for executing pulse slicing and optical exercising operations according to embodiments of the present invention.

FIG. 8 illustrates a laser energy monitoring system according to some embodiments of the present invention.

FIGS. 9 and 10 illustrate aspects of a pulse shape analyzing process using, among other components, the laser energy monitoring system shown in FIG. 8, according to one embodiment of the present invention.

FIG. 11 illustrates a timing diagram for executing pulse slicing for non-uniform incident power to the AOD scanning system.

FIG. 12 illustrates a timing diagram for executing RF exercising operations according to embodiments of the present invention.

FIG. 13 schematically illustrates a positioner according to another embodiment of the present invention.

FIG. 14 illustrates a timing diagram for executing pulse slicing and RF exercising operations according to embodiments of the present invention.

### DETAILED DESCRIPTION

Example embodiments are described herein with reference to the accompanying FIGS. Unless otherwise expressly stated, in the drawings the sizes, positions, etc., of components, features, elements, etc., as well as any distances therebetween, are not necessarily to scale, but are exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one node could be termed a “first node” and similarly, another node could be termed a “second node”, or vice versa. The section headings used herein are for organizational purposes only and are not to be construed as limiting the subject matter described.

Unless indicated otherwise, the term “about,” “thereabout,” “substantially,” etc., means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “below,” “beneath,” “lower,” “above,” and “upper,” and the like, may be used herein for ease of description to describe one element or feature's relationship to another element or feature, as illustrated in the FIGS. It should be recognized that the spatially relative terms are intended to encompass different orientations in addition to the orientation depicted in the FIGS. For example, if an object in the FIGS. is turned over, elements described as “below” or “beneath” other elements or features would then be oriented “above” the other elements or features. Thus, the exemplary term “below” can encompass both an orientation of above and below. An object may be otherwise oriented (e.g., rotated 90 degrees or at other orientations) and the spatially relative descriptors used herein may be interpreted accordingly.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

It will be appreciated that many different forms and embodiments are possible without deviating from the spirit and teachings of this disclosure and so this disclosure should not be construed as limited to the example embodiments set forth herein. Rather, these examples and embodiments are provided so that this disclosure will be thorough and complete, and will convey the scope of the disclosure to those skilled in the art.

### I. Discussion Concerning the Positioner, Generally

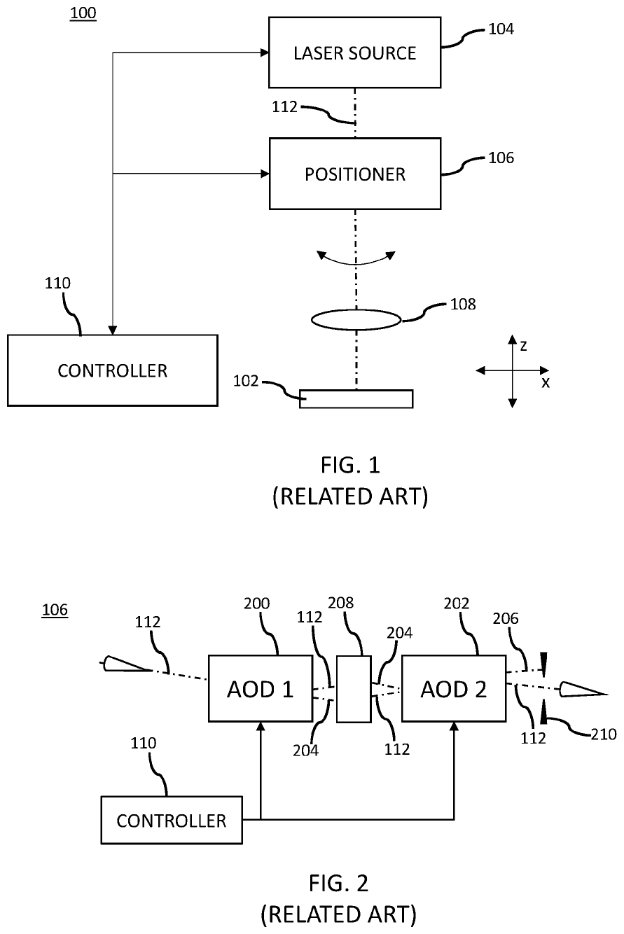

According to embodiments of the present invention, the AOD scanning system in the positioner 106 described above with respect to in FIG. 1 may be provided as exemplarily shown in FIG. 3 (i.e., as AOD scanning system 300). Referring to FIG. 3, the AOD scanning system 300 includes a first AOD 302 arranged and configured to deflect a beam path 112 along a first axis and a second AOD 304 arranged and configured to deflect the beam path 112 along a second axis (e.g., that is orthogonal to the first axis). In FIG. 3, the zeroth-order beam path of the first AOD 302 is identified at 306 and the zeroth-order beam path of the second AOD 304 is identified at 308. Likewise, the first-order beam path of the first AOD 302 is identified at 112′ and the second AOD 304 is identified at 112″. As will be appreciated, each of the first-order beam path 112′ and first-order beam path 112″ represent specific instances of a beam path along which the beam of laser energy can propagate (e.g., to the scan lens 108); therefore each of the beam path 112′ and beam path 112″ can also be generically referred to herein as “beam path 112” and, so, the first AOD 302 is arranged and configured to deflect the first-order beam path 112′ along a first axis of the AOD scanning system 300 and the second AOD 303 is arranged and configured to deflect the first-order beam path 112″ along a second axis of the AOD scanning system 300.

Furthermore, the AOD scanning system 300 shown in FIG. 3 includes a first beam trap 310 arranged and configured to intercept laser energy propagating along the zeroth-order beam path 306 (as well as laser energy propagating along the second- or higher order beam paths) without intercepting laser energy propagating along the first-order beam path 112′. Likewise, the AOD scanning system 300 includes a second beam trap 312 arranged and configured to intercept laser energy propagating along the zeroth-order beam path 308 (as well as laser energy propagating along the second- or higher order beam paths) without intercepting laser energy propagating along the first-order beam path 112″. Although not illustrated, the AOD scanning system 300 may further include a galvanometer mirror scanning system (e.g., comprised of a pair of galvanometer mirrors arranged and configured to deflect the beam of laser energy along two axes, as is known in the art) located in the beam path 112″ optically downstream of the second AOD 304.

Generally, the AO cell of each of the first AOD 302 and second AOD 304 is formed of a material that is susceptible to thermal lensing (e.g., as described above) in the presence of a beam of laser energy having a sufficiently high optical power propagating along the beam path 112. For example, the AO cell of each of the first AOD 302 and second AOD 304 can be formed of crystalline germanium. In this example, the beam of laser energy propagating along the beam path 112 would have a wavelength in a range from 2 μm (or thereabout) to 20 μm (or thereabout) and be of a sufficiently high average power (e.g., greater than or equal to 150 W, or thereabout) to induce thermal lensing within the AO cell of the first AOD 302 and the second AOD 304. In this case, the beam of laser energy can be generated by a laser source (e.g., the laser source 104) provided as a suitably high-power carbon dioxide or carbon monoxide gas laser, for example. Typically, high-power carbon dioxide or carbon monoxide gas lasers are configured to generate continuous wave (CW) or quasi-CW (QCW) beams of laser energy, or to generate beams laser energy comprised of discrete pulses (typically many tens of microseconds, or longer, in duration).

Although not illustrated, each of the first AOD 302 and the second AOD 304 includes at least one transducer attached to the AO cell thereof. Generally, the transducer is a piezoelectric transducer operative to vibrate in response to an externally-applied RF signal (i.e., drive signal). The transducer is attached to the AO cell of an AOD such that the vibrating transducer creates a corresponding acoustic wave that propagates within the AO cell. As will be understood by those of ordinary skill, the amplitude, frequency and duration of the acoustic wave correspond to the amplitude, frequency and duration of the RF power in the applied drive signal.

Drive signals can be applied to an input of the transducer by an associated RF driver. Thus the AOD scanning system 300 can, for example, include a first RF driver 314 electrically connected each transducer of the first AOD 302 and a second RF driver 316 electrically connected each transducer of the second AOD 304. Generally, each of the RF driver 314 and the second RF driver 316 can include an RF synthesizer, an amplifier coupled to an output of the RF synthesizer and an impedance matching circuit coupled to an output of the amplifier. The RF synthesizer (e.g., a DDS synthesizer) generates and outputs a preliminary signal of a desired frequency; the amplifier amplifies the preliminary signal to a desired amplitude, thereby transforming the preliminary signal into the drive signal; and the drive signal is applied to the input of the transducer via the impedance matching circuit.

Operations of the first RF driver 314 and the second RF driver 316 can be controlled in response to command signals output by a controller (e.g., controller 318) to generate drive signals of different frequencies and amplitudes, which can be rapidly applied (e.g., at rates up to or greater than 1 MHz) to each transducer of their respective AODs. The controller 318 will thus replace the controller 110 shown in FIG. 1, and may control an operation of the laser source 104 in addition to the operation of the AOD scanning system 300 and any other scanning system of positioner 106 (e.g., the galvanometer mirror scanning system). For purposes of facilitating disclosure, the act of applying a drive signal to a transducer of an AOD is also referred to herein as “driving” the AOD. Thus, when the first AOD 302 is driven by a drive signal applied from the first RF driver 314, a portion of the laser energy incident upon the AO cell of the first AOD 302 is diffracted to propagate along its first-order beam path 112′ to the AO cell of the second AOD 304, and another portion of the incident laser energy propagates along the zeroth-order beam path 306. If a drive signal is not applied from the first RF driver 314, then the laser energy incident upon the AO cell of the first AOD 302 simply propagates along the zeroth-order beam path 306. Likewise, when the second AOD 304 is driven by a drive signal applied from the second RF driver 316, a portion of the laser energy incident upon the AO cell of the second AOD 304 (i.e., propagating along the first-order beam path 112′) is diffracted to propagate along its first-order beam path 112″ (and, ultimately, on to scan lens 108), and another portion of the incident laser energy propagates along the zeroth-order beam path 308. If a drive signal is not applied from the second RF driver 316, then the laser energy incident upon the AO cell of the second AOD 304 simply propagates along the zeroth-order beam path 308.

Generally, when an AOD is driven in response to an applied drive signal, the ratio of optical power diffracted into the first-order beam path 112 vs. a zeroth-order beam path is determined by the amplitude of RF power in the applied drive signal and, in some cases, the frequency of the RF power in the applied drive signal. Furthermore, the amount of optical power diffracted into the first-order beam path 112 will increase with increasing RF power, until it reaches a maximum at some saturation level of RF power. The act of setting or otherwise modulating the amplitude of the RF power in a drive signal to be applied to the AOD is referred to herein as “amplitude modulation control.” The act of setting or otherwise adjusting the amount of optical power diffracted into the first order beam path 112 can be considered as setting or adjusting the “transmission” of the AOD.

When an AOD includes multiple transducers, the transmission of the AOD may also be adjusted by applying a drive signal to each of the transducers, wherein the RF frequency of each applied drive signal is the same, but slightly out of phase with one another. As a result, acoustic waves generated within the AO cell of the AOD interfere in at least a somewhat destructive manner. Such destructively-interfering acoustic waves have the effect of decreasing the transmission of the AOD, whereby the degree to which the AOD transmission is decreased corresponds to the degree to which the acoustic waves interfere destructively with each other within the AO cell. The act of selecting or otherwise modulating the phase relationship of drive signals to be applied to different transducers of a common AOD is referred to herein as “phase modulation control.” It should be noted, however, that phase modulation control cannot be used to completely prevent optical power from diffracted into the first order beam path 112.

By successively driving the first AOD 302 and second AOD 304 using drive signals of different frequencies, the AOD scanning system 300 can be operated to rapidly deflect the first-order beam path 112″ at different angles, to different positions within a two-dimensional scan field. Moreover, the amplitude of RF power in each drive signal successively applied to first AOD 302 and/or the second AOD 304 can be varied (if necessary) as a function of the frequency of the drive signal to ensure that amount of optical power propagating along the first-order beam path 112″ is at least substantially constant, regardless of the frequencies in the drive signals applied to the first AOD 302 and the second AOD 304.

According to embodiments discussed herein, the beam of laser energy propagating along the beam path 112 to the AOD scanning system 300 is generated by a suitably high-power laser (e.g., a carbon dioxide or carbon monoxide gas laser as described above) and the controller 318 is configured to operate the first RF driver 314 and the second RF driver 316 to drive the first AOD 302 and the second AOD 304, respectively, to create temporally-sliced pulses of laser energy from the incident beam. These temporally-sliced pulses of laser energy are thus output from the AOD scanning system 300 along beam path 112″ to propagate to the scan lens 108.

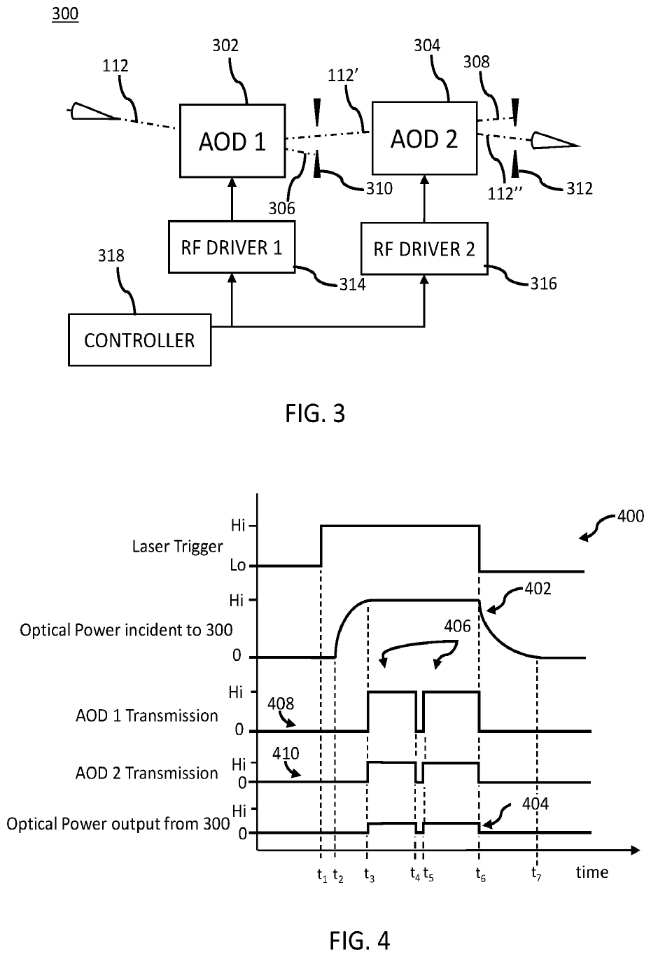

For example, and with reference to FIG. 4, the laser source 104 is operated (e.g., in response to an initial transition from a low state to a high state of a laser trigger command signal 400 output to the laser source 104 by the controller 318) to generate a beam of laser energy that includes a laser pulse 402. As exemplarily illustrated, the initial transition to the high state of the laser trigger command signal 400 begins at time t1 and ends at time t6. Optical power in the laser pulse 402 initially rises at time t2 before reaching an approximately constant level at (e.g., from time t3 to time t6). At time t6 (i.e., when the laser trigger command signal 400 transitions from the high state back to the low state), the optical power of laser pulse 402 begins to decay. At, for example, time t7, the optical power of the laser pulse 402 has decayed to zero or some otherwise negligible value. The portion of the laser pulse 402 between times t2 and t3 is herein referred to as the “head portion” of the laser pulse 402 and the portion of the laser pulse 402 between times t6 and t7 is herein referred to as the “tail portion” of the laser pulse 402. The portion of the laser pulse 402 between times t3 and t6 (i.e., the portion of the laser pulse 402 between the head and tail portions thereof) is herein referred to as the “main portion” of the laser pulse 402.

Although FIG. 4 illustrates a laser trigger command signal that in a constant “ON” state for the duration of the command, it will be appreciated that the laser trigger command signal can be modulated (e.g., pulse-width modulated) as desired (e.g., to prevent the laser source 104 from overheating, to adjust the optical power generated by the laser source, to vary the pulse duration of laser pulses generated by the laser source 104, or the like or any combination thereof). Further, although FIG. 4 illustrates only a single laser pulse 402 in the beam of laser energy generated by the laser source 104 in response to the laser trigger command signal 400, it will be appreciated that a series of laser trigger command signals, such as laser trigger command signal 400, could be output to the laser source 104, and that the laser source 104 would generate a beam of laser energy comprised of a series of laser pulses, such as laser pulse 402.

Referring now to FIGS. 3 and 4, to create a temporally-sliced pulse 404 from the main portion of the laser pulse 402, the first AOD 302 and the second AOD 304 are driven (in response to drive signals applied by the first RF driver 314 and the second RF driver 316, respectively) so that, during at least one common period 406 (also referred to herein as a “slice period”), laser energy incident upon the AO cell of the first AOD 302 and the second AOD 304 is diffracted to propagate along their respective first-order beam paths 112′ and 112″. Laser energy not diffracted by the first AOD 302 and the second AOD 304 into the first-order beam paths 112′ or 112″ (e.g., laser energy propagating along the zeroth-order beam paths 306 and 308) is intercepted by the first beam trap 310 and second beam trap 312. In the example timing diagram shown in FIG. 4, the first AOD 302 and the second AOD 304 diffract incident laser energy into their respective first-order beam paths 112 during two slice periods 406 (a first slice period between times t3 and t4 and a second slice period between times t5 and t6) to create two pulses 404, each of which has a pulse duration at least approximately equal the duration of its associated slice period 406. It should be appreciated that the first AOD 302 and the second AOD 304 may be driven during more or fewer than two slice periods 406, that each slice period 406 may be of any duration and that different slice periods 406 may be of the same or different durations.

In FIG. 4, the temporal transmission profile of the first AOD 302 (i.e., the transmission of the first AOD 302 as a function of time) obtained by applying drive signals from the first RF driver 314 to the first AOD 302 is indicated by line 408. Likewise, the temporal transmission profile of the second AOD 304 (i.e., the transmission of the second AOD 304 as a function of time) obtained by applying drive signals from the second RF driver 316 to the second AOD 304 is indicated by line 410. Thus, FIG. 4 illustrates an example in which two distinct drive signals have been applied to each of the first AOD 302 and the second AOD 304: two distinct drive signals are applied to the first AOD 302 to generate therein an acoustic wave during the aforementioned first slice period 406 and to generate therein an acoustic wave during the aforementioned second slice period 406; and two distinct drive signals are applied to the second AOD 304 to generate therein an acoustic wave during the aforementioned first slice period 406 and to generate therein an acoustic wave during the aforementioned second slice period 406.

For purposes of facilitating discussion herein, it is assumed that the drive signals applied to the first AOD 302 giving rise to the temporal transmission profile delineated by 408 have the same frequencies, and it is also assumed that the drive signals applied to the second AOD 304 giving rise to the temporal transmission profile delineated by 410 have the same frequencies. Alternatively, however, the frequency in the drive signal applied to the first AOD 302 giving rise to the temporal transmission profile delineated by 408 during the first slice period 406 can be different from the frequency in the drive signal applied to the first AOD 302 giving rise to the temporal transmission profile delineated by 408 during the second slice period 406. Likewise, the frequency in the drive signal applied to the second AOD 304 giving rise to the temporal transmission profile delineated by 410 during the first slice period 406 can be different from the frequency in the drive signal applied to the second AOD 304 giving rise to the acoustic waveform delineated by 410 during the second slice period 406. In these alternative cases, the amplitude and/or phase (in embodiments in which the first AOD 302 and/or the second AOD 304 include multiple transducers) of the drive signals applied to the first AOD 302 and/or the second AOD 304 and giving rise to the temporal transmission profiles delineated by 408 and 410 during the first and second slice periods 406 can be set (e.g., as discussed above) to ensure that the average optical power in the laser pulse 404 created during the first slice period 406 is at least substantially the same as the average optical power in the laser pulse created during the second slice period 406.

As shown in FIG. 4, there exists a minimum time delay between successive slice periods 406 (i.e., between times t4 and t5). This minimum time delay (also referred to herein as a “slice delay”) is selected so as to be sufficiently long (e.g., equal to or about 2 μs, 1 μs, 0.5 μs, 0.25 μs, 0.1 μs, etc., or between of these values, depending on one or more factors such as the amplitude and velocity of the acoustic wave propagating in the AO cell and the size of the optical aperture of the AOD) to allow transient acoustic waves in the AO cell of the first AOD 302 at the end of a preceding slice period 406 to dissipate before the first AOD 302 is driven to diffract when the subsequent slice period 406 begins. Taking into account the duration of the main portion of the laser pulse 402, the number of slice periods 406 to be present during the main portion of the laser pulse 402 and the slice delay between successive slice periods 406, the slice periods 406 created from a common laser pulse 402 may have a duration greater than or equal to 0.1 μs or thereabout (e.g., greater than or equal to 0.1 μs, 0.25 μs, 0.5 μs, 1 μs, 1.5 μs, 2 μs, 2.5 μs, 5 μs, 10 μs, etc., or between any of these values).

Provided as described above, the first beam trap 310 of the AOD scanning system 300 prevents the zeroth-order beam path 306 from reaching the AO cell of the second AOD 304, thereby avoiding problems discussed above with respect to FIG. 2 (concerning not-suitably-constant or -stationary thermal gradients within the AO cell of the second AOD 304). As will be apparent from FIG. 3, however, the AO cell of the first AOD 302 will always be exposed to laser energy propagating along the beam path 112 whereas the AO cell of the second AOD 304 will only be exposed to laser energy propagating from the first AOD 302 along the first-order beam path 112′. That is, the AO cell of the second AOD 304 will only be exposed to laser energy when the first AOD 302 is driven by the first RF driver 314 to produce a first-order beam propagating along the first-order beam path 112′.

### II. Discussion Concerning Optical Exercising

Because the AO cell of the second AOD 304 is formed of a material that is susceptible to thermal lensing in the presence of laser energy propagating from the first AOD 302 along the first-order beam path 112′, the AO cell of the second AOD 304 may introduce wavefront distortion effects such as described above, or none at all, to the beam of laser energy propagating therefrom along the first-order beam path 112″ (and, ultimately, to scan lens 108) depending on manner in which the first AOD 302 has been previously driven. For example if, prior to time t1 in FIG. 4, the laser source 104 generates a beam of laser energy comprised of a series of laser pulses propagating along beam path 112, but the first AOD 302 and the second AOD 304 are not driven during a slice period as discussed above to create a sliced pulse such as pulse 404, then a thermal gradient capable of inducing thermal lensing within the AO cell of the second AOD 304 will be absent within the AO cell of the second AOD 302 just prior to the beginning of the first slice period (i.e., at time t3). However, a thermal gradient capable of inducing thermal lensing may develop or evolve within the AO cell of the second AOD 304 during the first slice period (assuming the first slice period is sufficiently long in duration) or during a slice period subsequent to the first slice period (assuming that successive slice periods are sufficiently long in duration and sufficiently close together in time). Thus, the thermal gradient within the AO cell of the second AOD 304 will not be relatively constant, resulting in undesirable changes in wavefront distortion effects in beam of laser energy propagating from the second AOD 304 along the first-order beam path 112″ (and, ultimately, to scan lens 108).

To prevent or beneficially reduce the undesirable evolution of thermal gradients within the AO cell of the second AOD 304, the first AOD 302 is driven (in response to one or more drive signals applied by the first RF driver 314 as commanded by the controller 318) during one or more time periods (each referred to herein as a “optical exercise period”) occurring outside a slice period. However, the second AOD 304 is not driven during any optical exercise period. Thus, during an optical exercise period, laser energy incident upon the AO cell of the first AOD 302 is diffracted to propagate along its respective first-order beam path 112′ (e.g., as discussed above). The AO cell of the second AOD 304 then absorbs a portion of the laser energy propagating along the first-order beam path 112′ of the first AOD 302, which results in local heating of—and thermal lensing within—the AO cell of the second AOD 304. Heating of the second AOD 304 in this manner can herein be described as optically “exercising” the second AOD 304.

Generally, the timing and duration of the optical exercise periods are selected in order to ensure that the thermal gradient within the AO cell of the second AOD 304 is relatively constant over time so that changes in wavefront distortion effects are negligible or otherwise sufficiently reduced so as to ensure that a workpiece, such as workpiece 102, can be satisfactorily processed. For example, prior to time t1 in FIG. 4, the controller 318 may control an operation of the laser source 104 to generate a beam of laser energy comprising one or more laser pulses 402 propagating along beam path 112, but may not control the AOD scanning system 300 to create any sliced pulses, such as pulse 404, from any laser pulse 402 (or to otherwise drive the first AOD 302). In this example, a thermal gradient capable of inducing thermal lensing within the AO cell of the second AOD 304 will be absent within the AO cell of the second AOD 304 at the beginning of the first slice period described above with respect to FIG. 4 (i.e., at time t3 in FIG. 4). However, a thermal gradient capable of inducing thermal lensing may develop or evolve within the AO cell of the second AOD 304 during the first slice period described above with respect to FIG. 4 (assuming the first slice period is sufficiently long in duration) or during a slice period subsequent to the first slice period (assuming that successive slice periods are sufficiently long in duration and sufficiently close together in time).

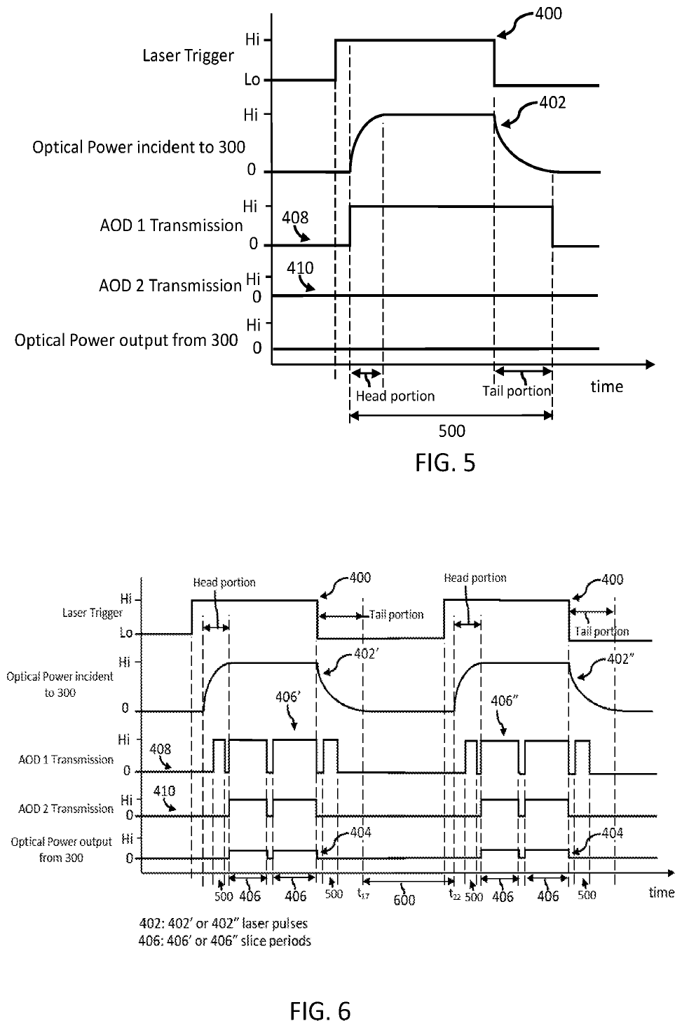

To prevent or beneficially reduce the undesirable evolution of thermal gradients within the AO cell of the second AOD 304 during a slice period or across successive slice periods, the controller 318 may cause an optical exercising operation to be performed, e.g., as shown in FIG. 5, by controlling an operation of the first RF driver 314 to drive the first AOD 302 (during optical exercise period 500) to diffract incident laser energy in each of the laser pulses 402 generated prior to the aforementioned time t1 into its first-order beam path 112′, so as to propagate the first-order beam from the first AOD 302 to the AO cell of the second AOD 304. Such driving of the first AOD 302 is exemplarily shown in FIG. 5, although only a single laser pulse 402 is illustrated for simplicity. As shown in FIG. 5, the controller 318 does not control an operation of the second RF driver 316 to drive the second AOD 304 during the optical exercise period 500 and, so, all laser energy incident upon the AO cell of the second AOD 304 is intercepted by the second beam trap 312.

Although FIG. 5 illustrates that the optical exercise period 500 lasts for the entire duration of the laser pulse 402 (including the entireties of the head portion and the tail portion of the laser pulse 402), it will be appreciated that the optical exercise period 500 may be shorter than the entire duration of the laser pulse 402, or that the first AOD 302 may be driven during successive optical exercise periods spanning the duration of the pulse 402. In this case, the first AOD 302 may not be driven during all or a portion of the head portion of the laser pulse 402, during all or a portion of the tail portion of the laser pulse 402, during all or a portion of the laser pulse 402 between the head and tail portions, or any combination thereof.

As mentioned above, although FIG. 4 illustrates only a single laser pulse 402 in the beam of laser energy generated by the laser source 104, a series of laser trigger command signals 400 would typically be output to the laser source 104 so that laser source 104 would typically generate a beam of laser energy comprised of a series of laser pulses 402, e.g., as shown in FIG. 6. If the duration between successively generated laser pulses 402 is sufficiently long, then the thermal gradient within the AO cell of the second AOD 304 during a preceding slice period 406 (e.g., slice period 406′, as shown in FIG. 6) associated with a preceding laser pulse 402 (e.g., laser pulse 402′, as shown in FIG. 6) may undesirably dissipate or diminish before a slice pulse, such as pulse 404, is to be created during a subsequent slice period 406 (e.g., slice period 406″, as shown in FIG. 6) associated with a subsequent laser pulse 402 (e.g., laser pulse 402″, as shown in FIG. 6). As a result, the wavefront distortion effects imparted to a pulse 404 by the AO cell of the second AOD 304 during the preceding slice period 406′ may be different from those imparted to a pulse 404 by the AO cell of the second AOD 304 during the subsequent slice period 406″. As will be appreciated, each of the laser pulses 402′ and 402″ represent specific instances of a laser pulse and, therefore, can also be generically referred to herein as a laser pulse 402.

To prevent or beneficially reduce the undesirable dissipation or diminishment of thermal gradients within the AO cell of the second AOD 304 between slice periods associated with successively-generated laser pulses 402 (e.g., between slice periods 406′and 406″, respectively associated with laser pulses 402′ and 402″), the controller 318 may cause one or more optical exercising operations to be performed, e.g., as shown in FIG. 6, by controlling an operation of the first RF driver 314 to drive the first AOD 302 to diffract incident laser energy in the tail portion of the laser pulse 402′ (and/or to diffract incident laser energy in the head portion of the laser pulse 402″) into its first-order beam path 112′, so as to propagate the first-order beam from the first AOD 302 to the AO cell of the second AOD 304. The period(s) during which the first AOD 302 is driven to diffract incident laser energy in the tail portion of the laser pulse 402′ (and/or to diffract incident laser energy in the head portion of the laser pulse 402″) are thus examples of the aforementioned “optical exercise period.”

As shown in FIG. 6, the controller 318 does not control an operation of the second RF driver 316 to drive the second AOD 304 during any optical exercise period and, so, all laser energy incident upon the AO cell of the second AOD 304 during the optical exercise period is intercepted by the second beam trap 312. As also shown in FIG. 6, the controller 318 can control the operation of the first RF driver 314 to drive the first AOD 302 to diffract incident laser energy in the head portion of the laser pulse 402′ (and/or to diffract incident laser energy in the tail portion of the laser pulse 402″) into its first-order beam path 112′, so as to propagate the first-order beam from the first AOD 302 to the AO cell of the second AOD 304 as needed or otherwise desired.

Further, as shown in FIG. 6, the controller 318 controls the operation of the first RF driver 314 such that there is a time delay between an optical exercise period and a subsequent successive slice period (and vice versa). If the time delay is between an optical exercise period 500 and a subsequent successive slice period 406 (e.g., as between the optical exercise period 500 and slice period 406″ associated with laser pulse 402″), then the duration of the time delay shall be sufficiently long (e.g., equal to or about 2 μs, 1 μs, 0.5 μs, 0.25 μs, 0.1 μs, etc., or between of these values, depending on one or more factors such as the amplitude and velocity of the acoustic wave propagating in the AO cell and the size of the optical aperture of the AOD) to allow transient acoustic waves in the AO cell of the first AOD 302 at the end of the optical exercise period 500 to dissipate before the first AOD 302 is driven to diffract when the subsequent successive slice period 406 begins. If the time delay is between a slice period 406 and a subsequent successive optical exercise period 500 (e.g., as between the slice period 406′ and optical exercise period 500 associated with laser pulse 402′), then the duration of the time delay can be less than, equal to or greater than the first time delay.

Although FIG. 6 illustrates only one optical exercise period 500 occurring during the head or tail portion of a laser pulse 402, it will be appreciated that multiple, intermittent optical exercise periods 500 may occur during any head or tail portion of a laser pulse 402. Further, although FIG. 6 illustrates that the optical exercise period 500 associated with any laser pulse 402 lasts for less than the entire duration of the head or tail portions of the laser pulse 402, it will be appreciated that the optical exercise period 500 associated with any laser pulse 402 may last for the entire duration of the head or tail portions of the laser pulse 402.

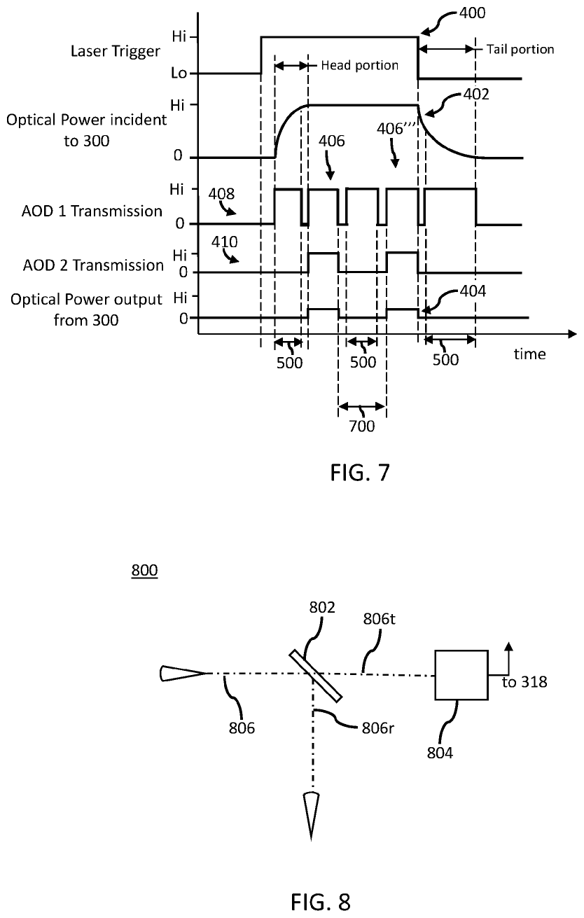

FIGS. 4 and 6 illustrate embodiments in which pulse slicing operations are performed so that the slice periods 406 occupy the entire duration of the laser pulse 402 between the head and tail portions, except for the aforementioned slice delay therebetween. In other embodiments, however, the controller 318 may cause one or more pulse slicing operations to be performed such that there exists at least one period of time between the head and tail portions of the laser pulse 402 having a duration that is greater than twice the duration of the slice delay (or thereabout) and that is outside a slice period. Such a period of time is hereinafter referred to as a “non-slice period.” The controller 318 may cause an optical exercising operation to be performed (e.g., as described above) during a non-slice period, provided that the first time delay exists between the attendant optical exercise period 500 and any subsequent slice period (e.g., as described above). For example, a non-slice period is exemplarily identified in FIG. 7 at 700, and an optical exercising operation is performed during an optical exercise period 500 within the non-slice period 700. As shown in FIG. 7, a first time delay exists between the optical exercise period 500 occurring during the non-slice period 700 and the subsequent slice period 406″, and a time delay also exists between the optical exercise period 500 occurring during the non-slice period 700 and the preceding slice period 406. As also shown in FIG. 7, optical exercising operations may also be performed in the head and/or tail portions of the laser pulse 402 (e.g., in the manner exemplarily described above with respect to FIG. 6).

From the embodiments discussed above, it will be appreciated that the controller 318 is configured to perform one or more optical exercising operations (e.g., as described above) during the entirety of any non-slice period, during the entirety of any head portion of a laser pulse, during the entire of any tail portion of a laser pulse, or any combination thereof. In other embodiments, the controller 318 causes optical exercising operations to be performed during only a portion of any non-slice period, during only a portion of any head portion of a laser pulse, during only a portion of any tail portion of a laser pulse, or any combination thereof. In embodiments in which the controller 318 causes optical exercising operations to be performed during only a portion of any non-slice period (as opposed to an entire non-slice period), during only a portion of a head portion of a laser pulse (as opposed to an entire head portion of the laser pulse) and/or during only a portion of any tail portion of a laser pulse (as opposed to an entire tail portion of the laser pulse), the optical exercise period 500 may be referred to as a “tailored optical exercise period” 500.

According to embodiments of the present invention, the duration of any tailored optical exercise period 500, during which an optical exercising operation is performed, can correspond to the optical power in the laser pulse (e.g., laser pulse 402) during the tailored optical exercise period 500. For example, less laser energy will be diffracted to the AO cell of the second AOD 304 during a tailored optical exercise period 500 that occurs near the beginning of the head portion (or near the end of the tail portion) of a laser pulse 402 as compared to a tailored optical exercise period 500 that occurs near the end of the head portion (or near the beginning of the tail portion) of the laser pulse 402. Accordingly, the controller 318 may be configured to perform an optical exercising operation during a relatively long tailored optical exercise period 500 occurring near the beginning of the head portion of a laser pulse 402 or during a relatively short tailored optical exercise period 500 occurring near the end of the head portion of the laser pulse 402. Likewise, the controller 318 may be configured to perform an optical exercising operation during a relatively short tailored optical exercise period 500 occurring near the beginning of the tail portion of a laser pulse 402 or during a relatively long tailored optical exercise period 500 occurring near the end of the tail portion of the laser pulse 402.

According to other embodiments of the present invention, the duration of any tailored optical exercise period 500, during which an optical exercising operation is performed, can also correspond to the actual or estimated thermal gradient within the AO cell of the second AOD 304 just prior to the tailored optical exercise period 500. To facilitate performance of an optical exercising operation during a tailored optical exercise period, the controller 318 may be provided with (or otherwise have access to, e.g., via one or more wired or wireless networks, not shown) pulse shape information describing the temporal optical power profile of the laser pulse 402 (i.e., from the beginning of the head portion to the end of the tail portion) or amount of energy within the laser pulse 402 in various temporal “slices” of the laser pulse 402.

### III. Discussion Concerning Pulse Shape Information, Generally

As mentioned above, the controller 318 may be provided with (or otherwise have access to, e.g., via one or more wired or wireless networks, not shown) pulse shape information to facilitate performance of an optical exercising operation during a tailored optical exercise period. The controller 318 may receive information indicating the pulse shape information associated with laser pulses to be generated by the laser source 104, or may otherwise derive such pulse shape information based on the received information. Such received information may be input (e.g., via a user interface of the apparatus 100, not shown) by a user or otherwise set by an operator or technician of the apparatus 100, read out from a computer file transmitted or otherwise conveyed to the controller 318, or the like or any combination thereof.

The pulse shape information may be stored (e.g., in a look-up table or other data structure in a computer memory of the controller 318 or otherwise accessible to the controller 318) in association with other information (also referred to herein as “supplemental information”) describing laser parameters under which the laser pulse 402 in the beam of laser energy is generated (e.g., the pulse duration of the laser pulse 402 generated by the laser source 104, the pulse repetition frequency at which the laser pulse 402 was generated, the average power at which the laser pulse 402 was generated, or the like or any combination thereof). The controller 318 may then use the pulse shape information and, optionally, any associated supplemental information, to determine when, during the creation of sliced pulses 404 from a laser pulse 402, any optical exercising operation should be performed, and for how long the optical exercising operation should be performed (i.e., the duration of the tailored optical exercise period 500) in order to maintain a substantially constant thermal gradient within the AO cell of the second AOD 304 during operation of the apparatus 100.

### A. Discussion Concerning Generation of Pulse Shape Information

In one embodiment, pulse shape information may be generated using any known or suitable laser energy monitoring system incorporated within the AOD scanning system 300, or otherwise within the apparatus 100 that includes the AOD scanning system 300. For example, and with reference to FIG. 8, a laser energy monitoring system 800 according to one embodiment of the present invention includes a mirror 802 and a laser sensor 804.

The mirror 802 is arranged within beam path 806 and is provided as a partially-transmissive mirror configured to reflect a majority of light in the incident beam of laser energy propagating along beam path 806 (into beam path 806r) and transmit a small amount of the light (e.g., 2% or thereabout) into beam path 806t. In FIG. 8, beam path 806 can be either of the zeroth-order beam paths 306 or 308 or either of the first-order beam paths 112′ or 112″. Thus, beam path 806r can propagate to the first beam trap 310 (if the beam path 806 is the zeroth-order beam path 306), to the second beam trap 312 (if the beam path 806 is the zeroth-order beam path 308), to the second AOD 304 (if the beam path 806 is the first-order beam path 112′), or to scan lens 108 or any other optical component located optically downstream of the AOD scanning system 300 (if the beam path 806 is the first-order beam path 112″).

The laser sensor 804 is arranged to receive laser energy transmitted through the mirror 802 (e.g., propagating along beam path 806t). In one embodiment, the laser sensor 804 is configured to measure the instantaneous optical power in the beam of laser energy incident thereon and generate sensor data based on the sensing or measurement. The sensor data can be output to the controller 318 by any suitable means (e.g., via wired or wireless communication, as is known in the art). The controller 318 causes the sensor data to be stored (e.g., locally within the controller 318, on some computer memory within the apparatus 100 accessible to the controller 318, on some computer memory located remote from the apparatus 100 but communicatively connected to the apparatus 100 via one or more networks) as pulse shape information describing the temporal optical power profile of the laser energy incident upon the laser sensor 804 over a set time duration (e.g., during a temporal “slice” of the laser pulse 402, as will be described in greater detail below).

In another embodiment, the sensor data output to the controller 318 can be further processed (e.g., time-integrated) to derive the energy content of the beam of laser energy incident upon the laser sensor 804 over the set time duration. In this embodiment, the processed sensor data can be stored (e.g., as described above) as pulse shape information describing the amount of energy within the laser pulse energy over the set time duration (e.g., during a temporal “slice” of the laser pulse 402, as will be described in greater detail below).

In another embodiment, the laser sensor 804 is provided as an integrating detector (e.g., configured to measure the instantaneous optical power in the beam of laser energy incident thereon and integrate the measured optical power to derive the energy content of the beam) and generate sensor data. The sensor data can be output to the controller 318 by any suitable means (e.g., via wired or wireless communication, as is known in the art) and is stored (e.g., as described above) as pulse shape information describing the amount of energy within the laser pulse energy over the set time duration (e.g., during a temporal “slice” of the laser pulse 402, as will be described in greater detail below).

In one embodiment, the laser source 104, AOD scanning system 300 and laser energy monitoring system 800 can be operated to perform a pulse shape analyzing process to generate the pulse shape information. During the pulse shape analyzing process, the laser source 104 is operated (e.g., as described above) to generate a beam of laser energy that includes a sequence of laser pulses 402 generated under a particular set of laser parameters. For example, all laser pulses in the sequence of laser pulses may have the same (or substantially the same) pulse duration, and all laser pulses may be generated at the same (or substantially the same) pulse repetition frequency.

The AOD scanning system 300 is operated (e.g., as described above) during the pulse shape analyzing process to cause laser energy in each laser pulse 402 of the sequence of laser pulses to propagate along the beam path 806 during at least one period of time (each period of time also referred herein to as the aforementioned temporal “slice” of the laser pulse 402 or, more simply, as a “slice window”). When the laser energy propagates along the beam path 806, the slice window can be considered to be “open”. When laser energy is not propagating along the beam path 806, the slice window can be considered “closed.” The duration of each slice window may be equal to or about 2 μs, 1 μs, 0.5 μs, 0.25 μs, 0.1 μs, 0.05 μs etc., or between of these values, and all slice windows created during a sequence of laser pulses have the same duration.

When a slice window is open, the laser sensor 804 generates the sensor data and outputs the same to the controller 318. The sensor data is stored (e.g., as discussed above) in association with other information, such as the aforementioned supplemental information as well as slice information describing temporal aspects of the slice window during which the sensor data was generated. Examples of slice information can include the time when the slice window opened (e.g., relative to the time when the laser trigger command signal transitioned from a low state to a high state, or the like), the time when the slice window closed (e.g., relative to the time when the laser trigger command signal transitioned from a low state to a high state, or the like), the duration of the slice window, or any combination thereof.

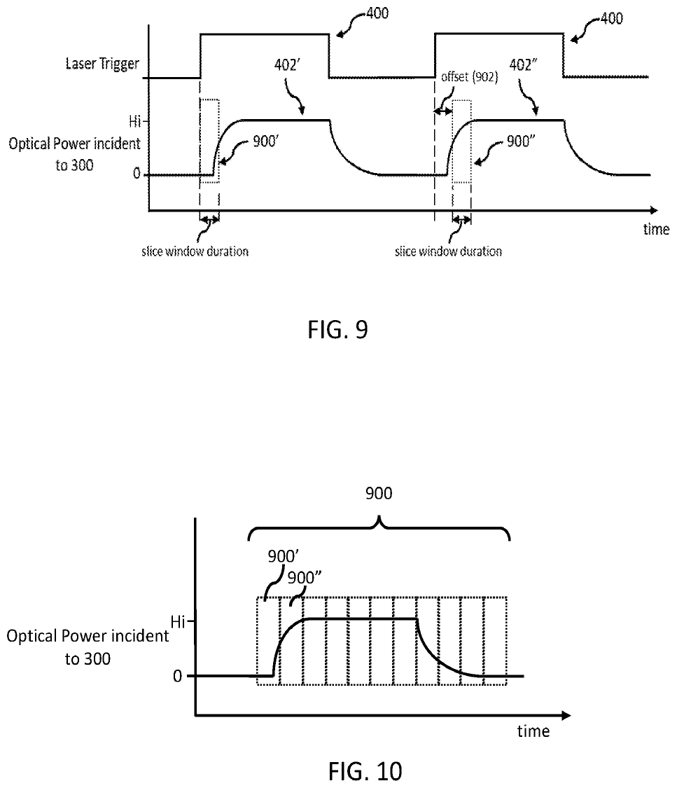

Generally, the duration of each slice window associated with a laser pulse 402 is less than the pulse duration of the laser pulse 402, but slice windows associated with different laser pulses 402 in the sequence of laser pulses 402 are opened and closed at different times so that sensor data generated by the laser sensor 804 effectively represents all portions of a representative laser pulse 402 in the sequence of laser pulses 402. For example, and with reference to FIG. 9, the laser source 104 is operated (e.g., as described above) to generate a beam of laser energy that includes a plurality of laser pulses 402 (for simplicity, only a first laser pulse 402′ and a second laser pulse 402″ in the sequence of laser pulses are shown). The AOD scanning system 300 is operated (e.g., as described above) so as to cause laser energy to propagate along the beam path 806 during at least one slice window associated with each laser pulse in the sequence of laser pulses (e.g., during a first slice window 900′ associated with the first laser pulse 402′ and during a second slice window 900″ associated with the second laser pulse 402″). As will be appreciated, each of the slice windows 900′ and 900″ represent specific instances of a slice window and, therefore, can also be generically referred to herein as slice window 900. The location of the second slice window 900″ within the temporal optical power profile of its associated laser pulse 402″ is temporally offset relative to the location of the first slice window 900′ within the temporal optical power profile of its associated laser pulse 402′, as indicated at 902. The offset is generally equal to the duration of the slice windows, but may be less than or greater than the duration of the slice windows. The AOD scanning system 300 is further operated (e.g., as described above) to cause laser energy of subsequent laser pulses 402 in the sequence of laser pulses to propagate along the beam path 806 during mutually-offset slice windows so that slice windows 900 have been created (and sensor data thus generated) for all portions of a laser pulse representative of all laser pulses 402 in the sequence of laser pulses 402 (see, e.g., FIG. 10).

### IV. Discussion Concerning RF Exercising

As mentioned above, the AO cells of each of the first AOD 302 and the second AOD 304 are formed of a material that is susceptible to thermal lensing in the presence of laser energy propagating along the beam path 112 or along the first-order beam path 112′. However, driving the first AOD 302 and the second AOD 304 will also result in heating of the AO cells therein in a manner sufficient to create thermal gradients capable of inducing thermal lensing effects such as those described above. Characteristics of the thermal gradient within an AO cell of an AOD will change depending on the manner in which the AOD is driven (e.g., taking into account the amount of RF energy and RF frequency(ies) applied to the AOD during a slice period). However, thermal gradients within the AO cells which induce the thermal lensing may dissipate in the absence of any laser energy propagating therethrough (e.g., during the period between time t17 of pulse 402′ and time t22 of pulse 402″, as shown in FIG. 6, when the AODs are not being driven; time t17 of pulse 402′ corresponds to t7 shown in FIG. 4 and time t22 of pulse 402″ corresponds to t2 shown in FIG. 4). As a result, the thermal gradients within the AO cells of the first AOD 302 and the second AOD 304 when pulse slicing operations are performed (e.g., on the laser pulse 402″ as shown in FIG. 6) may differ undesirably from the thermal gradients within the AO cells of the first AOD 302 and the second AOD 304 when pulse slicing operations are performed (e.g., on the laser pulse 402′ as shown in FIG. 6). Thus, across periods when laser energy from successive laser pulses 402 propagate through the AO cells of the first AOD 302 and the second AOD 304, the thermal gradients within these AO cells may undesirably change, leading to inconsistent deflection of laser pulses 402 incident upon the AOD scanning system 300.

To prevent or otherwise minimize undesirable changes in thermal gradients within the AO cells of the first AOD 302 and the second AOD 304 across periods when laser energy from successive laser pulses 402 propagate therethrough, the first AOD 302 and the second AOD 304 may be driven during inter-pulse intervals. As used herein, an “inter-pulse interval” refers to the time period when laser energy from successive laser pulses 402 does not propagate through the first AOD 302 and the second AOD 304 (e.g., interval 600, which occurs during the period between time t7 of pulse 402′ and time t2 of pulse 402″ as shown in FIG. 6). Driving the first AOD 302 and second AOD 304 during the inter-pulse interval 600 is herein referred to as “RF exercising,” which can be carried out during an RF exercising operation.

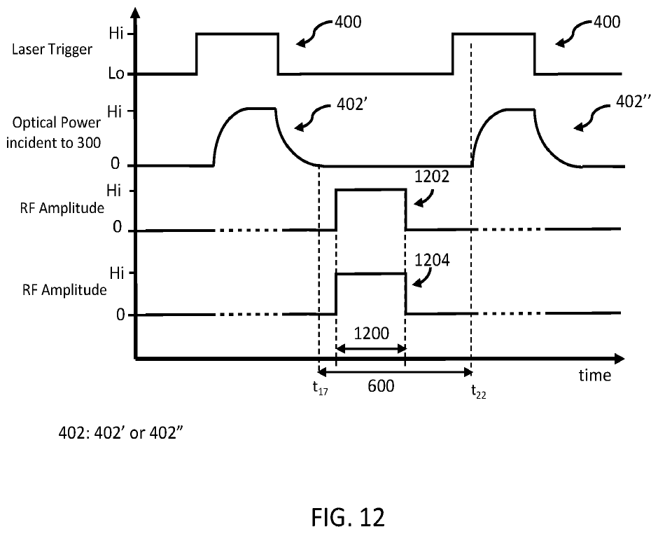

Referring to FIG. 12, the controller 318 may cause an RF exercising operation to be performed during an inter-pulse interval, such as inter-pulse interval 600. In FIG. 12, the drive signal applied to the first AOD 302 from the first RF driver 314 includes a first RF exercising pulse 1202 and the drive signal applied to the second AOD 304 from the second RF driver 316 includes a second RF exercising pulse 1204. As indicated in FIG. 12, the duration over which the first RF exercising pulse 1202 and second RF exercising pulse 1204 are applied is referred to herein as an RF exercise period 1200. The timing and duration of the RF exercise period 1200 may be selected in order to ensure that the thermal gradient within the AO cell of the second AOD 304 is relatively constant over time so that changes in wavefront distortion effects are negligible or otherwise sufficiently reduced so as to ensure that a workpiece, such as workpiece 102, can be satisfactorily processed.

The controller 318 controls the operation of the first RF driver 314 and second RF driver 316 such that there is a time delay between the RF exercise period 1200 and a subsequent successive slice period (occurring after time t22, as discussed above). Generally, the duration of the time delay should be sufficiently long (e.g., greater than or equal to or about 2 μs, 1 μs, 0.5 μs, 0.25 μs, 0.1 μs, etc., or between of these values, depending on one or more factors such as the amplitude and velocity of the acoustic wave propagating in the AO cell and the size of the optical aperture of the AOD) to allow transient acoustic waves in the AO cells of the first AOD 302 and the second AOD 304 at the end of the RF exercise period 1200 to dissipate before the first AOD 302 and the second AOD 304 are driven to diffract when a slice period 406 begins. Although not illustrated, it should be appreciated that the drive signals applied to the first AOD 302 and the second AOD 304 may contain other RF pulses of any suitable frequency, amplitude and duration (as symbolically represented by the dashed lines therein) in order to create the laser pulses 404 discussed above, in order to perform any of the optical exercising operations discussed above, or the like or any combination thereof.

The amplitude and duration of the first RF exercising pulse 1202 and second RF exercising pulse 1204 may also be chosen in any manner desired or beneficial, in order to ensure that the thermal gradient within the AO cells of the first AOD 302 and second AOD 304 are relatively constant over time so that changes in wavefront distortion effects are negligible or otherwise sufficiently reduced so as to ensure that a workpiece, such as workpiece 102, can be satisfactorily processed. In the embodiment shown in FIG. 12, the first and second RF exercising pulses 1202 and 1204 are shown as step functions. Alternatively, the amplitude of the first and second RF exercising pulses 1202 and 1204 may be shaped in other ways (e.g., sinusoidally) to achieve the desired thermal gradient in the AO cells. In yet another embodiment, the RF exercising pulses 1202 and 1204 may have different durations.

The RF frequency content of the RF exercising pulses 1202 and 1204 may also be chosen in any manner desired or beneficial. In some cases (e.g., depending on the configuration of the transducer(s) attached to the AO cell, the efficiency with which the transducer can launch an acoustic wave into the AO cell, etc.), absorption of RF energy by the AO cell may be dependent on the frequency of the drive signal. In one embodiment, the RF exercising pulses 1202 and 1204 may contain a subset of one or more discrete frequencies within a frequency band, or may contain all of such discrete frequencies. Furthermore, the frequencies of RF exercising pulses 1202 and 1204 applied during different RF exercise periods may be the same or different. That is, the frequency (or frequencies) in an RF exercise pulse applied during a first RF exercise period may be the same as or different from the frequency (or frequencies) in an RF exercise pulse applied during a second RF exercise period. For example, during a first RF exercise period 1200, a first subset of frequencies may be output to the transducer of first AOD 302 and/or second AOD 304 for the entirety of a RF exercise period 1200 and, during a subsequent RF exercise period 1200, a second subset of the frequencies (which may or may not contain some of the same frequencies included in the first subset) are output to the transducer of first AOD 302 and/or second AOD 304.

In another embodiment, the RF exercising pulses 1202 and 1204 may contain some or all of the frequencies within a specific frequency band by chirping or “smearing” the frequency of the RF exercising pulse during an RF exercise period. Generating and applying such chirped or “smeared” RF exercise pulses can be beneficial over RF exercise pulses containing one or more discrete frequencies (each also referred to herein as a “discrete frequency RF exercise pulse”) if a discrete frequency RF exercise pulse radiates an undesirable level of electromagnetic radiation (e.g., which could interfere with electronic devices in the vicinity of the laser-processing apparatus 100).

Although RF exercising has been discussed above in connection with AOD scanning system 300, it will also be appreciated that RF exercising may be performed with any system having any number of suitably-equipped AODs (e.g., a system having only one AOD, or a system having more than two AODs).

### V. Discussion Concerning Beam Trap Exercising

As described above, optical exercising may be beneficially used to maintain the thermal state of the AO cells in the first AOD 302 and the second AOD 304 when laser energy propagating through the first AOD 302 and the second AOD 304 is not to be propagated to the workpiece 102. As also described above, RF exercising may be employed to maintain the thermal state of the AO cells in the first AOD 302 and the second AOD 304 when no laser energy is propagating through the first AOD 302 or the second AOD 304 (and, thus, is not propagating to the workpiece 102); for example, during the aforementioned inter-pulse intervals.

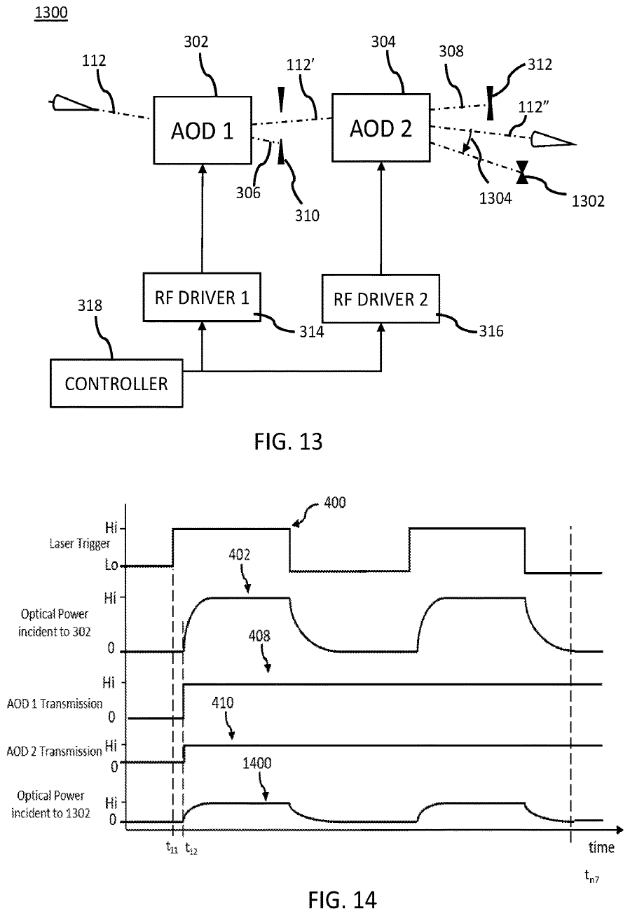

However, there can be situations when it is desirable to prevent the workpiece 102 from being irradiated with laser energy, while the laser source 104 is still generating a beam of laser energy (e.g., to maintain stable operation of the laser source 104), but for relatively long periods of time where optical exercising is not effective or feasible (e.g., because second AOD 304 is not being driven for a relatively long period of time while the first AOD 302 is being driven). Such situations can, for example, arise during workpiece processing where there is a long distance between features to be successively-formed in a workpiece, when a processed workpiece is being removed from (or loaded into) the system, etc. In order to maintain the thermal state of the AO cells in the first AOD 302 and the second AOD 304 during such situations, and with reference to FIG. 13, an AOD scanning system 1300 may be provided as exemplarily described with respect to the AOD scanning system 300, but may further include a third beam trap 1302 (also referred to herein as an “exercise beam trap 1302”) arranged and configured to intercept laser energy propagating thereto, and the first AOD 302 and the second AOD 304 of the AOD system 1300 may be driven to deflect the first order beam path 112″ to the exercise beam trap 1302 (e.g., as indicated by arrow 1304) such that the exercise beam trap 1302 intercepts laser energy propagating along the first-order beam path 112″. Driving the first AOD 302 and second AOD 304 in this manner is herein referred to as “beam trap exercising,” which can be carried out during a beam trap exercising operation.

Referring to FIG. 14, the controller 318 may cause a beam trap exercising operation to be performed by controlling an operation of the first RF driver 314 and second RF driver 312 to apply drive signals to the first AOD 302 and the second AOD 304 while laser energy in a series of multiple, successively-generated laser pulses 402 propagates through the AO cells thereof. In FIG. 14, the optical power in the first order beam path 112″ deflected to the exercise beam trap 1302 is indicated by line 1400.

The amplitude of the drive signals applied to the first AOD 302 and the second AOD 304 may be constant or may vary in any manner desired or beneficial to ensure that the thermal gradient within the AO cells of the first AOD 302 and second AOD 304 are relatively constant over time so that changes in wavefront distortion effects are negligible or otherwise sufficiently reduced so as to ensure that a workpiece, such as workpiece 102, can be satisfactorily processed.

In one embodiment, phase modulation control is additionally employed while driving the first AOD 302 and/or second AOD 304 reduce the optical power propagating along the beam path 112″ to the exercise beam trap 1302. Doing so can be desirable if the average or peak power in the laser energy that would otherwise propagate to the exercise beam trap 1302 along beam path 112″ would undesirably damage or degrade the beam trap 1302.

As shown in FIG. 14, the duration of the drive signals applied to the first AOD 302 and second AOD 304 from the first RF driver 314 and second RF driver 316, respectively, is significantly longer than the duration of a single laser pulse 402. In the illustrated embodiment, the drive signals applied from the first RF driver 314 and the second RF driver 316 at a time that is synchronized to the beginning of the head portion of a laser pulse 402 incident to the AO cell of the first AOD 302 (i.e., at time t12, which corresponds to the aforementioned time t2). In other embodiments, however, the drive signals may be applied prior to time t12 (e.g., between time t12 and time t11, which corresponds to the aforementioned time t1, or before time t11).

As should be apparent, the frequency of each drive signal applied from the first RF driver 314 and the second RF driver 316 is selected to direct laser energy propagating along the first-order beam path 112″ to the exercise beam trap 1302. Generally, the frequency of the drive signal applied from the first RF driver 314 (also referred to herein as a “first frequency”) can be any frequency within a first frequency range. Likewise, the frequency of the drive signal applied from the second RF driver 316 (also referred to herein as a “second frequency”) can be any frequency within a second frequency range. The bandwidth of the first frequency range can be larger than, equal to, or smaller than the bandwidth of the second frequency range. In one embodiment, the first frequency range overlaps the second frequency range (i.e., frequencies contained in the first frequency range are contained in the second frequency range). In another embodiment, the first frequency range does not overlap the second frequency range (i.e., frequencies contained in the first frequency range are not contained in the second frequency range, and vice versa).

The RF frequency content of the drive signals applied to the first AOD 302 and the second AOD 304 during a beam trap exercising operation may be chosen in any manner desired or beneficial. For example, the drive signal applied to the first AOD 302 may contain one or more discrete frequencies within the first frequency range, or may contain a plurality of frequencies within the first frequency range that are chirped or “smeared” as described above in embodiments relating to RF exercising. Likewise, the drive signal applied to the second AOD 304 may contain one or more discrete frequencies within the second frequency range, or may contain a plurality of frequencies within the second frequency range that are chirped or “smeared” as described above in embodiments relating to RF exercising.

Although beam trap exercising has been described above as involving use of the exercise beam trap in connection with an AOD scanning system 1300 that includes the exercise beam trap 1302, it will be appreciated that, in another embodiment, the exercise beam trap 1302 may be replaced with one or more optical components (e.g., one or more mirrors, lenses, or the like or any combination thereof) arranged and configured to intercept laser energy, propagating along the first-order beam path 112″ during a beam trap exercising operation, and redirect the laser energy into the first beam trap 310 or the second beam trap 312. In yet another embodiment, the second beam trap 312 may be configured to intercept laser energy, propagating from the second AOD 304 along the first-order beam path 112″ during a beam trap exercising operation.

Although beam trap exercising has been discussed above in connection with AOD scanning system 1300, it will also be appreciated that RF exercising may be performed with any system having any number of suitably-equipped AODs (e.g., a system having only one AOD, or a system having more than two AODs) and a beam trap. Furthermore, although FIG. 14 illustrates an embodiment in which beam trap exercising is performed to deflect two sequential laser pulses 402 to the beam trap 1302, it will be appreciated that beam trap exercising may be performed to deflect any number of such laser pulses 402 to the beam trap 1302.

### VI. Discussion Concerning Adjustment of Temporal Optical Power Profiles

As discussed above, the temporal transmission profiles of the first AOD 302 and second AOD 304 during a slice period, which are delineated by 408 and 410, respectively, is constant (or at least substantially constant) for the entire duration of slice period 406. As a result, the temporal optical power profile of a laser pulse 404 created during a slice period (i.e., the optical power in a laser pulse 404 output from the AOD scanning system 300, during a slice period, as a function of time) will be approximately congruent to the temporal optical power profile of the portion of the laser pulse 402 incident to the AOD scanning system 300 during the slice period. For example, during any slice period shown in FIG. 4-7 or 8-10, the temporal optical power profile of the laser pulse 402 incident to the AOD scanning system 300 and a laser pulse 404 output from the AOD scanning system 300 are essentially horizontally flat, indicating that the optical power in the incident laser pulse 402 and the output laser pulse 404 are approximately constant for the duration of the slice period 406. Thus, the temporal optical power profiles of portions of the laser pulse 402 during different slice periods will be the same (or approximately equal) and the temporal optical power profiles of the laser pulses 404 created during the slice periods will also be the same (or approximately equal). Ensuring that the temporal optical power profiles of the laser pulses 404 created during the slice periods are the same (or approximately equal) can be beneficial in facilitating development of a laser-based process to form a feature in a workpiece (e.g., to form a through- or blind-via in a workpiece such as a printed circuit board or integrated circuit substrate), or in forming multiple features using different laser pulses 404 sliced from a common laser pulse 402.

However, it can often be the case that the optical power in the main portion of the laser pulse 402 will vary undesirably. As a result, the temporal optical power profiles of portions of the laser pulse 402 during different slice periods will be sufficiently different from one another, making it difficult to efficiently develop laser-based processes and form multiple features using different laser pulses 404 sliced from a common laser pulse 402. In some embodiments, the temporal optical power profile of the laser pulse 402 can be adjusted by changing the manner in which the laser source 104 is operated (e.g., by varying the optical power of the laser pulses generated, by varying the pulse repetition rate, by varying the pulse duration of laser pulses generated, by modulating the duty cycle of the laser trigger command signal (e.g., via pulse-width modulation) applied to the laser source 104, or the like or any combination thereof).

As an alternative to (or in conjunction with) modifying the operation of the laser source 104, the amplitude and/or phase (in embodiments in which the first AOD 302 and/or the second AOD 304 includes multiple transducers) of the drive signals applied to the first AOD 302 and/or second AOD 304, which give rise to the temporal transmission profiles delineated by 408 and/or 410 respectively, during a slice period 406 can be made variable during the slice period 406 (e.g., as described above). According to embodiments of the present invention, the amplitude and/or phase of a drive signal applied to the first AOD 302 and/or second AOD 304 during a slice period 406 can be made variable such that the temporal optical power profile of a laser pulse 404 created during the slice period 406 is not approximately congruent to the temporal optical power profile of the portion of the laser pulse 402 incident to the AOD scanning system 300 during the slice period 406.

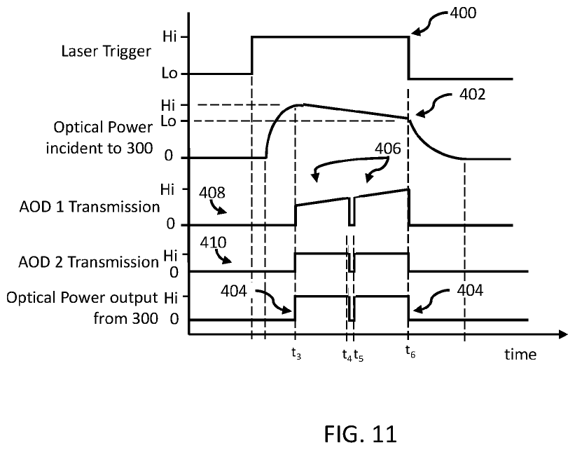

For example, and with reference to FIG. 11, the optical power in the laser pulse 402 is found to vary significantly (e.g., steadily decreasing from a relatively high optical power “Hi” at the aforementioned time t3 to a relatively low optical power “Lo” at the aforementioned time t6, where the optical power Lo may be in range from 5% to 15% lower than the optical power Hi). If the temporal transmission profiles of the first AOD 302 and second AOD 304 during the aforementioned first slice period 406 is constant, then the optical power in the laser pulse 404 created during the first slice period 406 will vary undesirably for the duration of the first slice period (e.g., steadily decreasing to yield a temporal optical power profile that is congruent to the temporal optical power profile of the portion of the laser pulse 402 incident upon the AOD scanning system 300 during the first slice period 406). Likewise, if the temporal transmission profiles during the aforementioned second slice period 406 is constant, then the optical power in the laser pulse 404 created during the second slice period 406 will vary undesirably for the duration of the second slice period (e.g., steadily decreasing to yield a temporal optical power profile that is congruent to the temporal optical power profile of the portion of the laser pulse 402 incident upon the AOD scanning system 300 during the second slice period 406). Moreover, assuming the pulse durations of the laser pulses 404 created during the first and second slice periods 406 are equal, the laser pulse 404 created during the second slice period 406 will undesirably have less pulse energy than the laser pulse 404 created during the first slice period 406.

Therefore, according to embodiments of the present invention, and as exemplarily shown in FIG. 11, the temporal transmission profiles of each drive signal applied to the first AOD 302 during the first and second slice periods 406 can be made variable (e.g., employing amplitude modulation control, phase modulation control, or a combination thereof) such that the temporal optical power profile of laser pulses 404 created during the first and second slice periods 406 are at least substantially horizontally flat (i.e., substantially constant over time). For example, amplitude modulation control and/or phase modulation control can be performed in driving the first AOD 302 during the first and second slice periods such that the temporal transmission profile of the first AOD 302 during the first and second slice periods is the inverse of the temporal optical power profile of portions of the laser pulse 402 incident upon the AOD scanning system 300 during the first and second slice periods 406. Furthermore, the amplitude modulation control and/or phase modulation control can be performed such that the temporal optical power of laser pulses 404 created during the first and second slice periods 406 are at least substantially equal. As a result, and assuming the pulse durations of the laser pulses 404 created during the first and second slice periods 406 are equal, the laser pulse 404 created during the second slice period 406 will desirably have the same pulse energy as the laser pulse 404 created during the first slice period 406.

Although FIG. 11 illustrates an embodiment in which the optical power of the laser pulse 402 is found to steadily decrease, it will be appreciated that the optical power of the laser pulse 402 may steadily increase, or decrease or increase in a sinusoidal, quasi-erratic or other non-linear manner, or the like or any combination thereof depending upon one or more factors such as the laser source 104 used to generate the beam of laser energy, the manner in which the laser source 104 is operated, the temperature of the laser source 104, environmental conditions (e.g., humidity, temperature) in the ambient environment surrounding the laser source 104, or the like or any combination thereof.

Furthermore, although FIG. 11 illustrates an embodiment in which the temporal transmission profile of the first AOD 302 during the first and second slice periods 406 is varied to ensure that the temporal optical power profile of laser pulses 404 created during the first and second slice periods 406 are at least substantially horizontally flat, it will be appreciated that the temporal transmission profile of the second AOD 304 during the first and second slice periods 406 may alternatively or additionally be varied to achieve the same goal.

Lastly, although it has been discussed above that the temporal transmission profile of the first AOD 302 and/or second AOD 304 can be varied in the presence of a portion of a laser pulse 402 having a temporal optical power profile that is not substantially horizontally flat be varied during a slice period to create a laser pulse 404 with temporal optical power profile that is at least substantially horizontally flat, it will be appreciated that the amplitude of the applied drive signal(s) can be varied in any other manner to create a laser pulse 404 having any other temporal optical power profile that is or is not approximately congruent to the temporal optical power profile of the portion of the laser pulse 402 present during the slice period.

To the extent that pulse shape information that describes or otherwise approximates temporal optical power profiles of laser pulses generatable by the laser source 104, such pulse shape information can be accessed by the controller 318. Thereafter, the controller 318 can generate data characterizing a temporal amplitude profile of at least one drive signal to be generated by at least one RF driver (e.g., the first RF driver 314, the second RF driver 316 or a combination thereof) that will result in the creation of a laser pulse 404 having a desired temporal optical power profile that is not congruent to the temporal optical power profile of the portion of the laser pulse 402 from which it was created. The controller 318 can thereafter output the data to the appropriate RF driver in the form of a command signal for the RF driver.

### VII. Additional Comments

Generally, the controller 118 includes one or more processors operative to generate the aforementioned commands and control signals (e.g., upon executing one or more instructions). A processor can be provided as a programmable processor (e.g., including one or more general purpose computer processors, microprocessors, digital signal processors, or any other suitable form of circuitry including programmable logic devices (PLDs), central processing units (CPUs), graphics processing units (GPUs), accelerated processing units (APUs), real-time processing units (RPUs), field-programmable gate arrays (FPGAs), field-programmable object arrays (FPOAs), application-specific integrated circuits (ASICs)—including digital, analog and mixed analog/digital circuitry—or the like, or any combination thereof) operative to execute the instructions. Execution of instructions can be performed on one processor, distributed among multiple processors, made parallel across processors within a device or across a network of devices, or the like or any combination thereof.

Generally, the instructions may be embodied as software (e.g., an executable code, file, library file, or the like or any combination thereof), hardware configuration (e.g., in the case of FPGAs, ASICs, etc.), or the like or any combination thereof, which can be readily specified by artisans, from the descriptions provided herein (e.g., written in C, C++, Visual Basic, Java, Python, Tel, Perl, Scheme, Ruby, assembly language, hardware description language such as LUCID, VHDL or VERILOG, etc.). Software is commonly stored in one or more data structures conveyed by tangible media such as computer memory, which is accessible (e.g., via one or more wired or wireless communications links) by a processor. Examples of tangible media include magnetic media (e.g., magnetic tape, hard disk drive, etc.), optical discs, volatile or non-volatile semiconductor memory (e.g., RAM, ROM, NAND-type flash memory, NOR-type flash memory, SONOS memory, etc.), or the like or any combination thereof, and may be accessed locally, remotely (e.g., across a network), or any combination thereof.

Although various embodiments of the present invention have been described above with respect to FIGS. 1-11 in association with operating the AOD scanning system 300 in the presence of laser pulses 402, it will be appreciated that these embodiments may likewise be practiced to operate the AOD scanning system 300 in the presence of CW or QCW beams of laser energy. Likewise, although beam trap exercising has been described above with respect to FIGS. 13 and 14 in connection with deflecting a beam of laser energy manifested by a train of laser pulses 402, it should be appreciated that beam trap exercising techniques may be employed when the beam of laser energy generated by the laser source 104 is manifested as a CW or QCW beam of laser energy. Additionally, although FIGS. 4, 6, 7 and 14 illustrate embodiments in which the first AOD 302 is driven to higher transmission levels than the second AOD 304, it will be appreciated that the first AOD 302 and first AOD 304 may be driven to equal transmission levels, or the second AOD 304 may be driven to higher transmission levels than the first AOD 302, or the first AOD 302 may be alternately and repeatedly driven to higher and lower transmission levels than the second AOD 304. Moreover, the embodiments discussed above in connection with the acquisition and processing of pulse shape information and adjustment of temporal optical profiles may be applied to CW or QCW beams of laser energy to ensure that the sliced laser pulses 404 have a consistent temporal optical power profile, or any other desired or suitable distribution of temporal optical power profiles, across successive pulse slices.

### VIII. Conclusion

The foregoing is illustrative of embodiments and examples of the invention and is not to be construed as limiting thereof. Although a few specific embodiments and examples have been described with reference to the drawings, those skilled in the art will readily appreciate that many modifications to the disclosed embodiments and examples, as well as other embodiments, are possible without materially departing from the novel teachings and advantages of the invention. For example, although embodiments concerning exercising operations have been described above as being used with the beam positioner shown in FIG. 3, it will be appreciated that the first AOD 200 in the beam positioner 106 shown in FIG. 2 may also be driven to implement the exercising operations described herein. Accordingly, all such modifications are intended to be included within the scope of the invention as defined in the claims. For example, skilled persons will appreciate that the subject matter of any sentence, paragraph, example or embodiment can be combined with subject matter of some or all of the other sentences, paragraphs, examples or embodiments, except where such combinations are mutually exclusive. The scope of the present invention should, therefore, be determined by the following claims, with equivalents of the claims to be included therein.

What is claimed is:

1. A system, comprising:
a first acousto-optic deflector (AOD) operative to diffract an incident beam of laser energy to thereby produce and output therefrom a first beam of laser energy and a second beam of laser light;
a second AOD arranged to receive the first beam of laser energy and operative to diffract the received first beam of laser energy to thereby produce and output therefrom a third beam of laser energy and a fourth beam of laser energy;
at least one first beam trap arranged and configured to absorb the second beam of laser energy output from the first AOD;
at least one second beam trap arranged and configured to absorb the fourth beam of laser energy output from the second AOD;
a controller communicatively coupled to the first AOD and to the second AOD, wherein the controller is configured to operate of the first AOD while not operating the second AOD.

2. The system of claim 1, wherein at least one selected from the group consisting of the first AOD and the second AOD includes an AO cell formed of a material that is susceptible to thermal lensing in the presence of the laser energy.

3. The system of claim 1, wherein at least one selected from the group consisting of the first AOD and the second AOD includes an AO cell formed of germanium.

4. The system of claim 1, wherein the controller is configured to:
operate the first AOD while not operating the second AOD during a first time period; and
operate the first AOD while operating the second AOD during a second time period.

5. The system of claim 4, wherein the second time period is after the first time period.

6. The system of claim 1, wherein a portion of the incident beam of laser energy is characterizable by a first temporal optical power profile,
the controller is further configured to operate of the first AOD and the second AOD simultaneously to create from the incident beam of laser energy at least one laser pulse, and
wherein the at least one laser pulse has a second temporal optical power profile, and
wherein the first temporal optical power profile and the second temporal optical power are not congruent.

7. The system of claim 6, wherein the beam of laser energy is a quasi-continuous wave (QCW) beam of laser energy.

8. The system of claim 6, wherein the first temporal optical power profile is not flat.

9. The system of claim 6, wherein the second temporal optical power profile is at least substantially flat.

10. The system of claim 1, wherein
the beam of laser energy is manifested as a sequence of laser pulses propagatable along a beam path, the plurality of laser pulses being temporally separated from each other by an inter-pulse interval,
the controller is further configured to operate of the first AOD and the second AOD during the inter-pulse interval by driving the first AOD and the second AOD at a plurality of frequencies.

11. A system, comprising:
a first AOD operative to diffract an incident beam of laser light to thereby produce and output therefrom a first beam of laser light and a second beam of laser light;
a second AOD arranged to receive the first beam of laser light and operative to diffract the received first beam of laser light to thereby produce and output therefrom a third beam of laser light;
at least one first beam trap arranged and configured to absorb the second beam of laser light output from the first AOD;
at least one exercise beam trap arranged and configured to absorb the third beam of laser light output from the second AOD; and
a controller communicatively coupled to the first AOD and to the second AOD, wherein the controller is configured to command a first RF driver to apply a first drive signal to a transducer of the first AOD and command a second RF driver to apply a second drive signal to a transducer of the second AOD, wherein the controller is operative to:
during a high state of a laser trigger command, operate the first AOD to diffract the incident beam of laser light along an exercise beam path to the second AOD, the second AOD configured to diffract the beam of laser light from the first AOD along an exercise beam path to an exercise beam trap, by applying a drive signal to a transducer of the first AOD and applying a drive signal to the second AOD, wherein the drive signal is modulated through a range of RF frequencies, thereby controlling a temperature gradient within the first AOD and the second AOD.
